(19) United States
(12) Patent Application Publication
(10) Pub. No.: US 2024/0394866 A1
(43) Pub. Date: Nov. 28, 2024

(54) MULTI-DEVICE AUTOMATED OPTICAL INSPECTION

(71) Applicant: Nanotronics Imaging, Inc., Cuyahoga Falls, OH (US)

(72) Inventors: Nadine Wong, Brooklyn, NY (US); Pal Pedersen, Harrison, NY (US); Jacob Keith, Brooklyn, NY (US)

(73) Assignee: Nanotronics Imaging, Inc., Cuyahoga Falls, OH (US)

(21) Appl. No.: 18/669,252

(22) Filed: May 20, 2024

Related U.S. Application Data
(60) Provisional application No. 63/503,630, filed on May 22, 2023.

(51) Int. Cl. G06T 7/00; G01N 21/95; G06T 7/73; G06V 20/50; G06V 20/70

(52) U.S. Cl. CPC G06T 7/001; G01N 21/9505; G06T 7/0006; G06T 7/74; G06V 20/50; G06V 20/70; G06T 2207/30148

(57) ABSTRACT

A computing system receives, from an inspection device, an image of a multi-device substrate having one or more regions. Each region of the one or more regions having a plurality of devices formed thereon. The computing system identifies a golden die corresponding to the multi-device substrate. The golden die represents a canonical design of devices formed on the multi-device substrate. The computing system analyzes the image to identify defects in the image of the multi-device substrate by comparing the image of the multi-device substrate to the golden die. The computing system maps locations of the identified defects to corresponding locations on the golden die. The computing system, based on the mapping, determines, by the computing system, one or more devices of the plurality of devices affected by the defects. The computing system generates, as output, an indication of the defects and the one or more devices affected by the defects.

### CROSS-REFERENCE TO RELATED APPLICATIONS

This application claims priority to U.S. Provisional Application Ser. No. 63/503,630, filed May 22, 2023, which is hereby incorporated by reference in its entirety.

### FIELD OF DISCLOSURE

Embodiments disclosed herein generally relate to a system and method of multi-device automated optical inspection.

### BACKGROUND

Defect analysis is one of the processes involved in the substrate manufacturing process. During defect analysis, a substrate is scanned using one or more imaging techniques. The scanned images of the substrate are then analyzed in order to determine whether a defect exists.

### SUMMARY

In some embodiments, an inspection system is disclosed herein. The inspection system includes an inspection device and a computing system. The inspection device is configured to capture one or more images of a multi-device substrate. The multi-device substrate includes one or more regions. Each region of the one or more regions having a plurality of devices formed thereon. The computing system is in communication with the inspection device. The computing system is configured to identify defects on the multi-device substrate by performing operations. The operations include receiving, from the inspection device, an image of the multi-device substrate. The operations further include identifying a golden die corresponding to the multi-device substrate. The golden die represents a canonical design of devices formed on the multi-device substrate. The operations further include analyzing the image to identify defects in the image of the multi-device substrate by comparing the image of the multi-device substrate to the golden die. The operations further include mapping locations of the identified defects to corresponding locations on the golden die. The operations further include, based on the mapping, determining one or more devices of the plurality of devices affected by the defects. The operations further include generating, as output, an indication of the defects and the one or more devices affected by the defects.

In some embodiments, a method of identifying defects on a multi-device substrate is disclosed herein. A computing system receives, from an inspection device, an image of a multi-device substrate. The multi-device substrate includes one or more regions. Each region of the one or more regions having a plurality of devices formed thereon. The computing system identifies a golden die corresponding to the multi-device substrate. The golden die represents a canonical design of devices formed on the multi-device substrate. The computing system analyzes the image to identify defects in the image of the multi-device substrate by comparing the image of the multi-device substrate to the golden die. The computing system maps locations of the identified defects to corresponding locations on the golden die. The computing system, based on the mapping, determines, by the computing system, one or more devices of the plurality of devices affected by the defects. The computing system generates, as output, an indication of the defects and the one or more devices affected by the defects.

In some embodiments, a non-transitory computer readable medium is disclosed herein. The non-transitory computer readable medium has one or more sequences of instructions stored thereon, which, when executed by a processor, causes a computing system to perform operations. The operations include receiving, by a computing system from an inspection device, an image of a multi-device substrate. The multi-device substrate includes one or more regions. Each region of the one or more regions has a plurality of devices formed thereon. The operations further include identifying, by the computing system, a golden die corresponding to the multi-device substrate. The golden die represents a canonical design of devices formed on the multi-device substrate. The operations further include analyzing, by the computing system, the image to identify defects in the image of the multi-device substrate by comparing the image of the multi-device substrate to the golden die. The operations further include mapping, by the computing system, locations of the identified defects to corresponding locations on the golden die. The operations further include, based on the mapping, determining, by the computing system, one or more devices of the plurality of devices affected by the defects. The operations further include generating, by the computing system, as output, an indication of the defects and the one or more devices affected by the defects.

### BRIEF DESCRIPTION OF FIGURES

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 is a block diagram illustrating a computing environment, according to some embodiments.

FIG. 2 is a block diagram illustrating a computing system of the computing environment of FIG. 1, according to some embodiments.

FIG. 3 is a flow diagram illustrating a method for inspecting a multi-device substrate, according to some embodiments.

FIG. 4 illustrates an example image that fails according to the fail criteria, according to some embodiments.

FIG. 5 illustrates an example image that fails according to the fail criteria, according to some embodiments.

FIGS. 6A-6B illustrate exemplary scanned images with defects, according to some embodiments.

FIGS. 7A-7B illustrate exemplary scanned images with defects, according to some embodiments.

FIG. 8A is a block diagram illustrating a computing device, according to example embodiments of the present disclosure.

FIG. 8B is a block diagram illustrating a computing device, according to example embodiments of the present disclosure.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

One or more techniques disclosed herein provide a system and method for performing an optical analysis on a multi-device substrate. A recent trend in device fabrication is movement from single device patterned substrates to multi-device patterned substrates, in which multiple types of devices are formed on a single substrate. As those skilled in the art understand, inspecting a multi-device patterned substrate for defects is a significantly more difficult task compared to single device patterned substrates.

For example, many conventional inspection methods involve comparing adjacent devices to each other to establish what is nominally present versus anomalously present. In a multi-device sample, this adjacency analysis cannot be performed, because adjacent devices look completely different. If, for example, a sample includes ten devices, conventionally, inspection tools would have to scan the substrate ten separate times, which increases the time it takes to inspect substrates. In a multi-device scan, conventional inspection methods now have to keep track of all the different design types, and cleanly scan each one individually so that we its system can generate the correct golden template for each distinct type. In customer contexts, this is a 10× multiplier on the overhead and time required to set up a recipe. For a 10-type wafer, this process takes 10× the time to set up, and keeping all these things organized is almost impossible. It is a very large challenge that makes performing automated inspection almost untenable. In conventional approaches, if they wish to inspect a substrate five times throughout the manufacturing process, they would have to reproduce all that extra work five times. As those skilled in the art understand, such process can quickly spiral out of the realm of what is reasonable to manage.

To account for this trend, the present disclosure provides an approach for detecting defects on a multi-device substrate. For example, to account for the multiple devices, the present approach involves performs a scan of the substrate. Similar to a single device analysis, the scan may include a plurality of blocks, with each block having the multiple devices formed thereon. To account for the multiple devices, each block may be treated as a single device, despite having multiple devices formed thereon. Accordingly, each block may be analyzed individually to determine whether a defect is present or not. The detected defects may then be mapped back to the original layout of the scanned substrate.

The automated optical inspection allows for scanning multiple devices with one scan, analyzing individual devices with varying patterns within a patterned substrate, and applying pass or fail criteria according to individual device regions.

This approach overcomes certain technical barriers such as inconsistent device pitches between repeating images. Additionally, the device pitches may cause timing and/or positioning problems during image acquisition scanning phases.

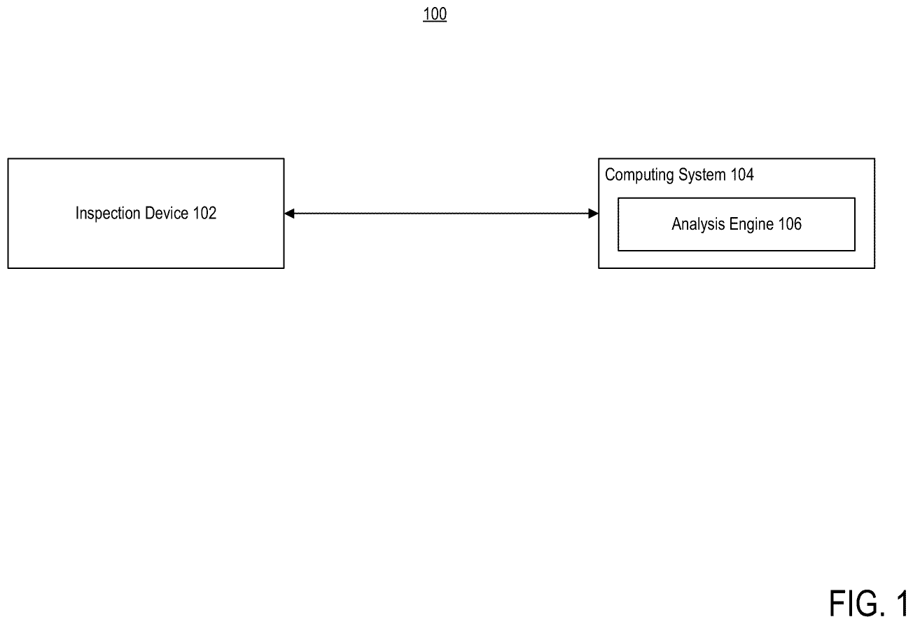

FIG. 1 is a block diagram illustrating a computing environment 100, according to some embodiments. As shown, computing environment 100 may include an inspection device 102 and a computing system 104 in communication with the inspection device 102.

In some embodiments, inspection device 102 may be configured to image or scan a multi-device substrate. In some embodiments, a multi-device substrate may refer to a substrate upon which multiple devices are formed or fabricated. In some embodiments, the multi-device substrate may include a plurality of blocks, with each block having two or more devices formed or fabricated thereon. In some embodiments, the layout or organization of the multiple devices in each block may be consistent. For example, the layout or organization of the multiple devices on one block will be the same across all blocks. In some embodiments, the layout or organization of the multiple devices may change or alternate across blocks.

Inspection device 102 may include one or more light sources configured to illuminate a multi-device substrate. In some embodiments, the one or more light sources may be representative of brightfield light sources (i.e., the one or more light sources may be configured to provide direct light to the multi-device substrate). In some embodiments, the one or more lights sources may be representative of darkfield light sources (i.e., the one or more light sources may be configured to provide oblique light to the multi-device substrate). In some embodiments, the one or more lights sources may be configurable between brightfield lighting and darkfield lighting. In either case, illumination provided by the one or more light sources may be reflected from a surface of the multi-device substrate and captured using a camera of the inspection device 102. For example, an image sensor of the camera of inspection device 102 may be configured to capture the reflected light from the surface of the multi-device substrate. In some embodiments, the one or more light sources may be movable to a plurality of different positions about the multi-device substrate such that images of the multi-device substrate may be captured under a variety of lighting positions and/or lighting conditions.

Inspection device 102 may provide the captured images of the multi-device substrate to computing system 104 for analysis. In some embodiments, computing system 104 may be a component of inspection device 102. In some embodiments, computing system 104 may be separate from inspection device 102. For example, computing system 104 may be in communication with inspection device 102 via one or more communication channels. In some embodiments, the one or more communication channels may be representative of individual connections via the Internet, such as cellular, wired, or wireless networks. In some embodiments, the one or more communication channels may connect terminals, services, or mobile devices using direction connections, such as radio frequency identification (RFID), near-field communication (NFC), Bluetooth™, low-energy Bluetooth™ (BLE), Wi-Fi™, ZigBee™, ambient backscatter communication (ABC) protocols, universal serial bus (USB), wide area network (WAN), local area network (LAN), or combinations thereof.

Computing system 104 may be configured to analyze the multi-device substrate for defects. Computing system 104 may include an analysis engine 106. Analysis engine 106 may include one or more software modules. The one or more software modules may be collections of code or instructions stored on a media (e.g., memory of computing system 104) that represent a series of machine instructions (e.g., program code) that implements one or more algorithmic steps. These machine instructions may be the actual computer code the processor interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Analysis engine 106 may be configured to analyze images of the multi-device substrate and identify defects contained therein. For example, analysis engine 106 may include one or more computer vision and/or machine learning modules trained to analyze images of specimens (e.g., single device specimens and/or multi-device specimens) and identify defects contained thereon. As those skilled in the art understand, inspecting a multi-device patterned substrate for defects is a significantly more difficult task compared to single device patterned substrates. To account for this, analysis engine 106 may be configured to treat each block of devices on the multi-device substrate as a single device, despite having multiple devices formed thereon. Analysis engine 106 may use a golden tic or template associated with multi-device template to map the detected defects to specific formed on the multi-device substrate. For example, as those skilled in the art understand, a golden die represents an ideal representation of a device design to be fabricated. In other words, the golden die may be used as the benchmark or standard to which images of the substrates are compared to ensure consistent quality and performance in production. In the context of multi-device substrates, the golden die may indicate the locations of each device in each block on the multi-device substrate. Accordingly, in operation, when analysis engine 106 identifies a defect in a given block of the multi-device substrate, analysis engine 106 may map the location of the defect in the given block to a particular device in that location based on a comparison of the location to the golden die. In this manner, analysis engine 106 may more efficiently and accurately identify defects on multi-device substrates.

As those skilled in the art understand, this approach may be applied to a variety of device designs. For example, a user or operator may upload or provide analysis engine 106 with the golden die corresponding to the type of multi-device substrate being analyzed. In this manner, analysis engine 106 may be applied across a plurality of different device designs.

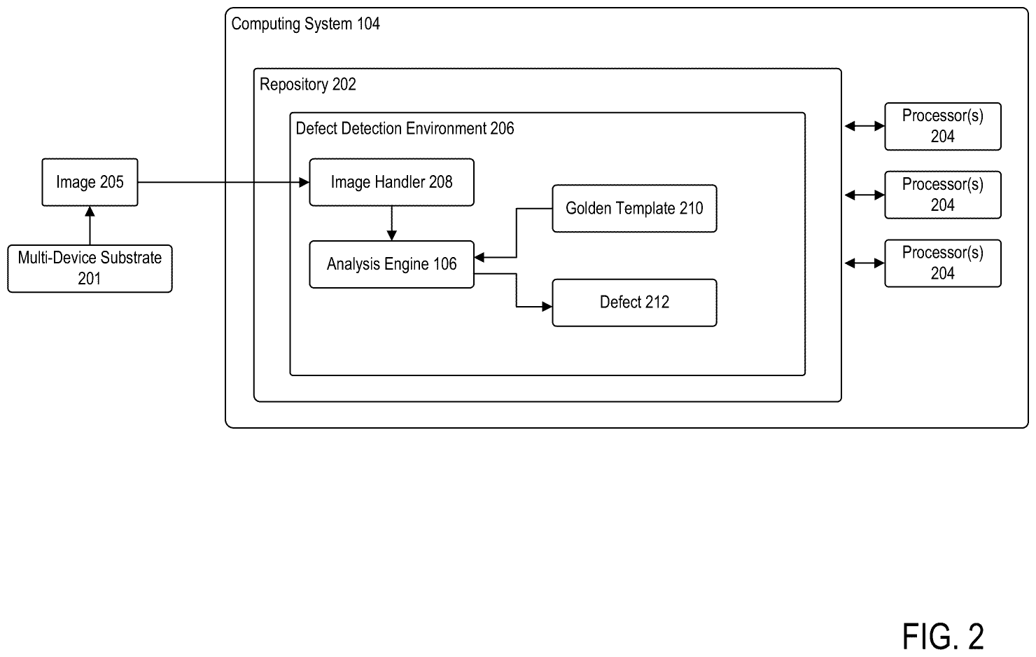

FIG. 2 is a block diagram illustrating computing system 104, according to example embodiments. As shown, FIG. 2 may represent an analysis environment in which analysis engine analyzes images of multi-device substrates to identify defects contained thereon. Computing system 104 may include a repository 202 and one or more computer processors 204.

Repository 202 may be representative of any type of storage unit and/or device (e.g., a file system, database, collection of tables, or any other storage mechanism) for storing data. Further, repository 202 may include multiple different storage units and/or devices. The multiple different storage units and/or devices may or may not be of the same type or located at the same physical site. As shown, repository 202 includes at least defect detection environment 206.

Defect detection environment 206 may include image handler 208 and analysis engine 106. Image handler 208 may include one or more software modules. The one or more software modules can be collections of code or instructions stored on a media (e.g., memory of computing system 104) that represent a series of machine instructions (e.g., program code) that implements one or more algorithmic steps. These machine instructions may be the actual computer code the processor of computing system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

As shown, image handler 208 may receive image 205 of multi-device substrate 201. Image 205 may be representative of an image captured by inspection device 102 under various lighting conditions. In some embodiments, image handler 208 may be configured to pre-process image 205 prior to analysis. For example, image handler 208 may be configured to upscale or downscale the image, based on the type of techniques implemented by image handler 208. In some embodiments, image handler 208 may be configured to applying a re-formatting operation to image 205, such as, but not limited to, applying a grey-scaling operation to image 205, applying a brightening operation to image 205, and the like. In some embodiments, image handler 208 may not perform any pre-processing operations to image 205; instead, image handler 208 may provide the raw image to analysis engine 106 for analysis.

Analysis engine 106 may receive image 205 from image handler 208. Analysis engine 106 may identify a golden template 210 corresponding to the design associated with multi-device substrate 201. In some embodiments, analysis engine 106 may identify a defect 212 in image 205 by comparing image 205 to golden template 210. In some embodiments, when analysis engine 106 identifies defect 212, analysis engine 106 may also identify a location corresponding to defect 212. In some embodiments, the location may take the form of coordinates corresponding to a plane in which multi-device substrate 201 is imaged. Based on the location corresponding to defect 212, analysis engine 106 may map defect 212 to a specific device in the block in which defect 212 was identified.

In some embodiments, analysis engine 106 may perform this analysis using a device mask that may be created for the multi-device substrate. In some embodiments, a region mask may also be created by using custom threshold to image tiles that make up the full image. The created masks may be generic or specific based on the devices being imaged. For the specific mask, the imaged device may be specifically chosen. In some embodiments, region masks may be iteratively applied such that a region mask for each region may be utilized.

As output, analysis engine 106 may generate a report that lists the devices and those defects identified on each device.

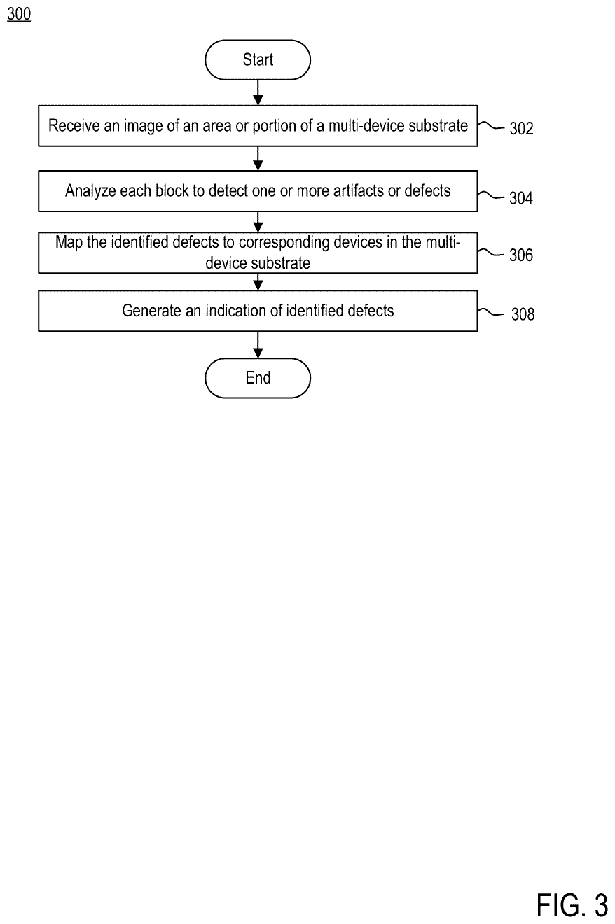

FIG. 3 is a flow diagram illustrating a method 300 for inspecting a multi-device substrate, according to some embodiments. Method 300 may begin at step 302.

At step 302, computing system 104 may receive an image of an area or portion of a multi-device substrate from inspection device 102. In some embodiments, the image of the multi-device substrate may be captured using brightfield imaging techniques. In some embodiments, the image of the multi-device substrate may be captured using darkfield imaging techniques. In some embodiments, the image may represent the entirety of the multi-device substrate. In some embodiments, the image may represent only a portion or subset of the multi-device substrate. Generally, the multi-device substrate may be partitioned, divided, or sectioned into a plurality of blocks. Each block may include a plurality of devices formed thereon.

At step 304, computing system 104 may analyze each block to detect one or more artifacts or defects present in the block. In some embodiments, computing system 104 may identify the one or more artifacts or defects using one or more artificial intelligence algorithms. For example, computing system 104 may employ one or more artificial intelligence algorithms or computer vision algorithms in comparing the image of the multi-device substrate to a golden die or template corresponding to the design of the multi-device substrate. Based on this comparison, computing system 104 may identify one or more artifacts or defects.

At step 306, computing system 104 may map the identified defects to corresponding devices formed on the multi-device substrate. In some embodiments, computing system 104 may perform this analysis on a block-by-block basis. More generally, for each artifact or defect, computing system 104 may compare the location of the detected artifact or defect to the golden die of the multi-device substrate. In this manner, computing system 104 may map the artifact or defect to a specific device formed on the multi-device substrate.

In some embodiments, computing system 104 may perform this analysis using a device mask that may be created for the multi-device substrate. In some embodiments, a region mask may also be created by using custom threshold to image tiles that make up the full image. The created masks may be generic or specific based on the devices being imaged. For the specific mask, the imaged device may be specifically chosen.

At step 308, computing system 104 may generate an indication of identified defects. For example, in some embodiments, based on the mapping, computing system 104 may generate a report that indicates the number of defects detected and/or the devices affected by those defects. In some embodiments, computing system 104 may apply a pass or fail criteria for each block or device. The pass or fail criteria may indicate which blocks or devices passed or failed inspection based on various factors, such as, but not limited to the type of block, the type of device, the location of detected defects, the types of detected defects, a number of detected defects on a given device or block, and the like. For example, a device may fail inspection if it includes a defect larger than 6 microns. In some embodiments, the indications generated by computing system 104 may take the form of a report that indicates a status of each block or device. For example, the report may indicate one or more of: which blocks passed inspection, which blocks failed inspection, which devices passed inspection, which devices failed inspection, a number of defects for each block, a number of defects for each device, a type corresponding to each defect, and the like.

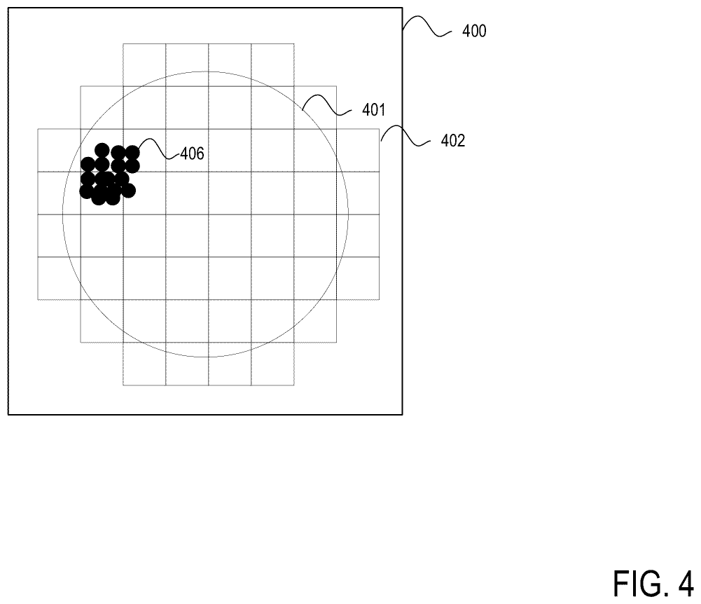

FIG. 4 illustrates an example image 400 of a multi-device substrate 401, according to example embodiments. As shown, image 400 may include a plurality of blocks 402 overlaying substrate 401. Each block 402 may include a plurality of devices formed thereon. For the purpose of defect detection, computing system 104 may treat each block 402 of the plurality of blocks 402 as a single “device.” Each mark 406 may correspond to a detected defect.

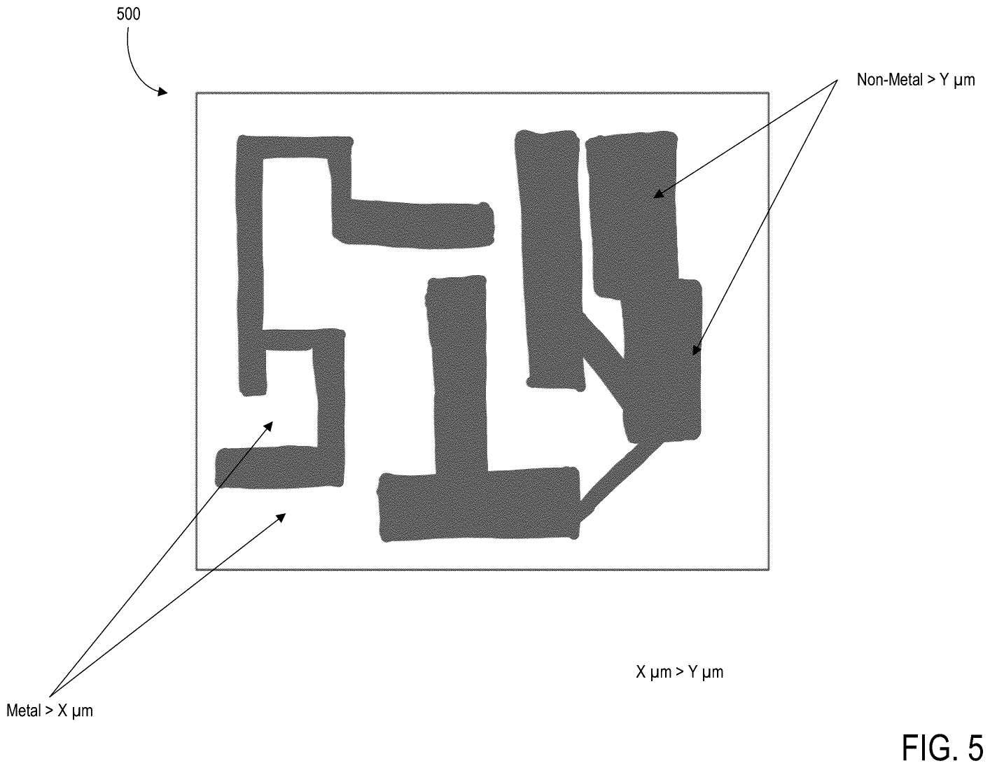

FIG. 5 illustrates an example image of a device 500 formed on a multi-device substrate, according to example embodiments. For purposes of this example, device 500 may depict a defect that satisfies a fail criteria set by an operator. As shown, the metal and non-metal regions are labeled, accordingly. The fail criteria may provide, for example, that device 500 may be deemed “failed,” if a defect exceeds a pre-determined size. The pre-determined size may be the fail criteria in this example.

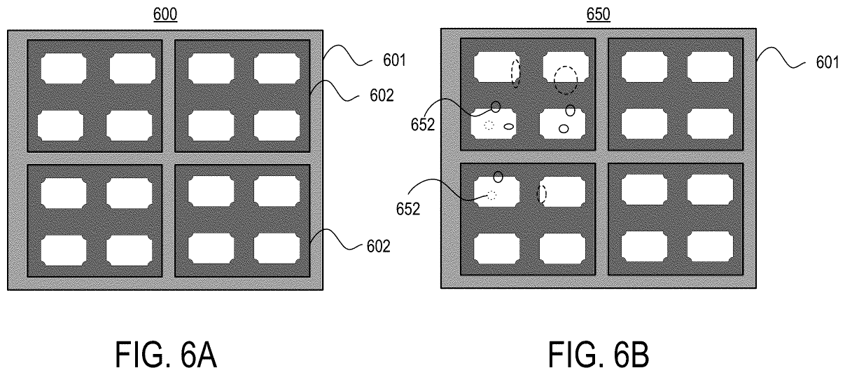

FIGS. 6A-6B illustrated scanned images with defects contained thereon, according to some embodiments. For case of discussion, FIG. 6A depicts a raw image 600 of multi-device substrate 601 and FIG. 6B illustrates an annotated image 650 of multi-device substrate 601 corresponding to raw image 600.

Referring to FIG. 6A, element 602 may designate a block on multi-device substrate 601. For purposes of analysis by analysis engine 106, element 602 may be treated as if it is a singular device. As shown, although a single element 602 is called out, multi-device substrate 601 may include a plurality of elements, with each element including a plurality of devices formed thereon, but treated as a single device for purposes of analysis.

Referring to FIG. 6B, image 650 may include one or more annotations 652. Each annotation 652 may designate a defect identified during analysis. In some embodiments, the size of the defect may be reflected in the size of the annotation corresponding thereto. For example, a larger annotation may indicate a larger defect. In some embodiments, the type of annotation 652 may indicate the type of defect identified. For example, a first annotation having a solid line may represent a defect within a first size range; a second annotation having a dashed line may represent a defect within a second size range; and third annotation having a dotted line may represent a defect within a third size range. As those skilled in the art understand, addition annotation types may be used to represent defects of a different size range. These defects may be compiled into a report provided to an end user.

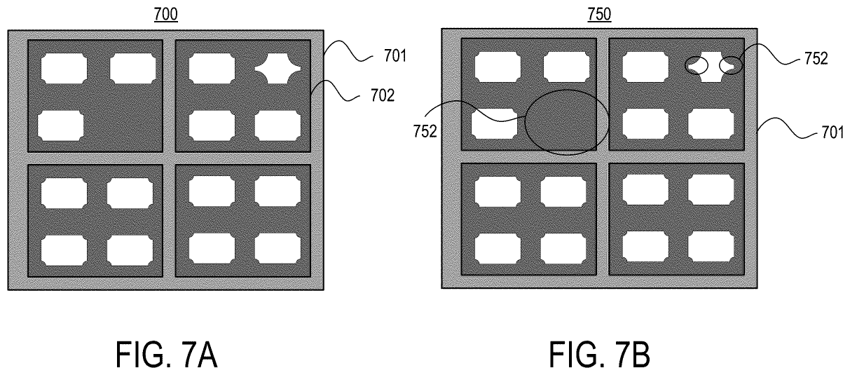

FIGS. 7A-7B illustrate exemplary scanned images with defects, according to some embodiments. For case of discussion, FIG. 7A depicts a raw image 700 of multi-device substrate 701 and FIG. 7B illustrates an annotated image 750 of multi-device substrate 701 corresponding to raw image 700.

Referring to FIG. 7A, element 702 may designate a block on multi-device substrate 701. For purposes of analysis by analysis engine 106, element 702 may be treated as if it is a singular device. As shown, although a single element 702 is called out, multi-device substrate 701 may include a plurality of elements, with each element including a plurality of devices formed thereon, but treated as a single device for purposes of analysis.

Referring to FIG. 7B, image 750 may include one or more annotations 752. Each annotation 752 may designate a defect identified during analysis. In some embodiments, the size of the defect may be reflected in the size of the annotation corresponding thereto. For example, a larger annotation may indicate a larger defect. In some embodiments, the type of annotation 752 may indicate the type of defect identified. For example, a first annotation having a solid line may represent a defect within a first size range; a second annotation having a dashed line may represent a defect within a second size range; and third annotation having a dotted line may represent a defect within a third size range. As those skilled in the art understand, addition annotation types may be used to represent defects of a different size range. These defects may be compiled into a report provided to an end user.

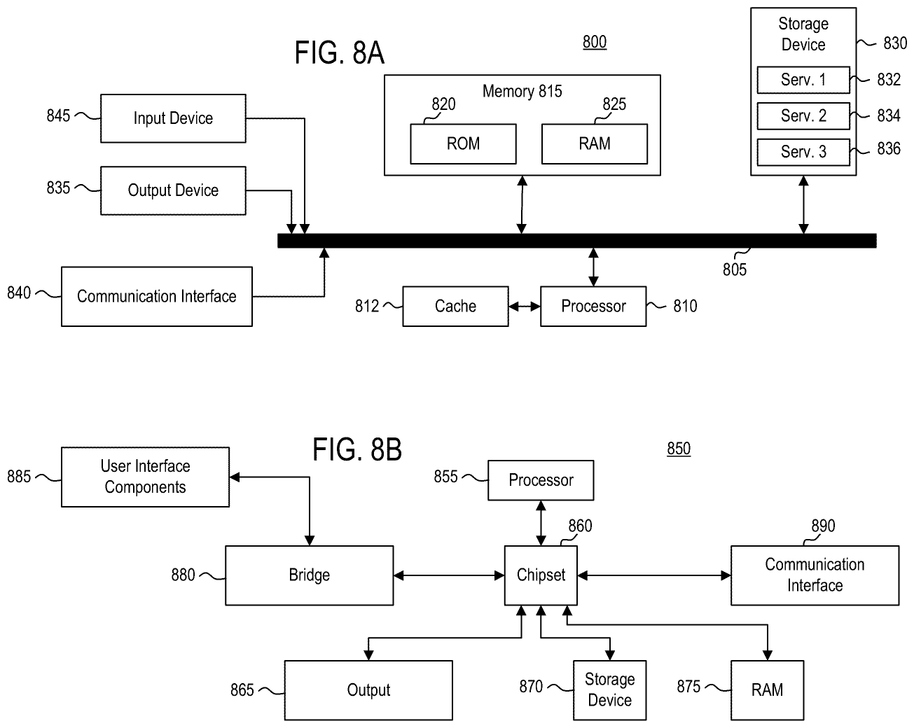

FIG. 8A illustrates a system bus architecture of computing system 800, according to example embodiments. System 800 may be representative of at least computing system 104. One or more components of system 800 may be in electrical communication with each other using a bus 805. System 800 may include a processing unit (CPU or processor) 810 and a system bus 805 that couples various system components including the system memory 815, such as read only memory (ROM) 820 and random-access memory (RAM) 825, to processor 810.

System 800 may include a cache of high-speed memory connected directly with, in close proximity to, or integrated as part of processor 810. System 800 may copy data from memory 815 and/or storage device 830 to cache 812 for quick access by processor 810. In this way, cache 812 may provide a performance boost that avoids processor 810 delays while waiting for data. These and other modules may control or be configured to control processor 810 to perform various actions. Other system memory 815 may be available for use as well. Memory 815 may include multiple different types of memory with different performance characteristics. Processor 810 may include any general-purpose processor and a hardware module or software module, such as service 1 832, service 2 834, and service 3 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction with the computing system 800, an input device 845 may represent any number of input mechanisms, such as a microphone for speech, a touch-sensitive screen for gesture or graphical input, keyboard, mouse, motion input, speech and so forth. An output device 835 may also be one or more of a number of output mechanisms known to those of skill in the art. In some instances, multimodal systems may enable a user to provide multiple types of input to communicate with computing system 800. Communications interface 840 may generally govern and manage the user input and system output. There is no restriction on operating on any particular hardware arrangement and therefore the basic features here may easily be substituted for improved hardware or firmware arrangements as they are developed.

Storage device 830 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 825, read only memory (ROM) 820, and hybrids thereof.

Storage device 830 may include services 832, 834, and 836 for controlling the processor 810. Other hardware or software modules are contemplated. Storage device 830 may be connected to system bus 805. In one aspect, a hardware module that performs a particular function may include the software component stored in a computer-readable medium in connection with the necessary hardware components, such as processor 810, bus 805, output device 835 (e.g., display), and so forth, to carry out the function.

FIG. 8B illustrates a computer system 850 having a chipset architecture that may represent computing system 104. Computer system 850 may be an example of computer hardware, software, and firmware that may be used to implement the disclosed technology. System 850 may include a processor 855, representative of any number of physically and/or logically distinct resources capable of executing software, firmware, and hardware configured to perform identified computations. Processor 855 may communicate with a chipset 860 that may control input to and output from processor 855.

In this example, chipset 860 outputs information to output 865, such as a display, and may read and write information to storage device 870, which may include magnetic media, and solid-state media, for example. Chipset 860 may also read data from and write data to storage device 875 (e.g., RAM). A bridge 880 for interfacing with a variety of user interface components 885 may be provided for interfacing with chipset 860. Such user interface components 885 may include a keyboard, a microphone, touch detection and processing circuitry, a pointing device, such as a mouse, and so on. In general, inputs to system 850 may come from any of a variety of sources, machine generated and/or human generated.

Chipset 860 may also interface with one or more communication interfaces 890 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 855 analyzing data stored in storage device 870 or storage device 875. Further, the machine may receive inputs from a user through user interface components 885 and execute appropriate functions, such as browsing functions by interpreting these inputs using processor 855.

It may be appreciated that example systems 800 and 850 may have more than one processor 810 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. An inspection system, comprising:
an inspection device configured to capture one or more images of a multi-device substrate, the multi-device substrate comprising one or more regions, each region of the one or more regions having a plurality of devices formed thereon; and
a computing system in communication with the inspection device, the computing system configured to identify defects on the multi-device substrate by performing operations comprising:
receiving, from the inspection device, an image of the multi-device substrate;
identifying a golden die corresponding to the multi-device substrate, the golden die representing a canonical design of devices formed on the multi-device substrate;
analyzing the image to identify defects in the image of the multi-device substrate by comparing the image of the multi-device substrate to the golden die;
mapping locations of the identified defects to corresponding locations on the golden die;
based on the mapping, determining one or more devices of the plurality of devices affected by the defects; and
generating, as output, an indication of the defects and the one or more devices affected by the defects.

2. The inspection system of claim 1, further comprising:
identifying a first region of the one or more regions of the multi-device substrate; and
determining whether the first region fails inspection based on an amount and types of defects identified in the first region.

3. The inspection system of claim 1, further comprising:
identifying a first device of the plurality of devices formed on the multi-device substrate; and
determining whether the first device fails inspection based on an amount and types of defects identified in a location corresponding to the first device.

4. The inspection system of claim 1, wherein analyzing the image to identify defects in the image of the multi-device substrate by comparing the image of the multi-device substrate to the golden die comprises:
applying a device mask to the image of the multi-device substrate, the device mask corresponding to the golden die.

5. The inspection system of claim 1, wherein analyzing the image to identify defects in the image of the multi-device substrate by comparing the image of the multi-device substrate to the golden die comprises:
iteratively applying one or more region masks to the one or more regions in the image of the multi-device substrate.

6. The inspection system of claim 1, wherein generating, as output, the indication of the defects and the one or more devices affected by the defects comprises:
generating an annotated image of the multi-device substrate corresponding to the image of the multi-device substrate, the annotated image comprising annotations corresponding to the identified defects.

7. The inspection system of claim 6, wherein a size, a shape, or a type of annotation is based on a determined type of defect.

8. A method of identifying defects on a multi-device substrate, comprising:
receiving, by a computing system from an inspection device, an image of a multi-device substrate, the multi-device substrate comprising one or more regions, each region of the one or more regions having a plurality of devices formed thereon;
identifying, by the computing system, a golden die corresponding to the multi-device substrate, the golden die representing a canonical design of devices formed on the multi-device substrate;
analyzing, by the computing system, the image to identify defects in the image of the multi-device substrate by comparing the image of the multi-device substrate to the golden die;
mapping, by the computing system, locations of the identified defects to corresponding locations on the golden die;
based on the mapping, determining, by the computing system, one or more devices of the plurality of devices affected by the defects; and
generating, by the computing system, as output, an indication of the defects and the one or more devices affected by the defects.

9. The method of claim 8, further comprising:
identifying, by the computing system, a first region of the one or more regions of the multi-device substrate; and
determining, by the computing system, whether the first region fails inspection based on an amount and types of defects identified in the first region.

10. The method of claim 8, further comprising:
identifying, by the computing system, a first device of the plurality of devices formed on the multi-device substrate; and
determining, by the computing system, whether the first device fails inspection based on an amount and types of defects identified in a location corresponding to the first device.

11. The method of claim 8, wherein analyzing, by the computing system, the image to identify defects in the image of the multi-device substrate by comparing the image of the multi-device substrate to the golden die comprises:
applying a device mask to the image of the multi-device substrate, the device mask corresponding to the golden die.

12. The method of claim 8, wherein analyzing, by the computing system, the image to identify defects in the image of the multi-device substrate by comparing the image of the multi-device substrate to the golden die comprises:
iteratively applying one or more region masks to the one or more regions in the image of the multi-device substrate.

13. The method of claim 8, wherein generating, as output, the indication of the defects and the one or more devices affected by the defects comprises:
generating an annotated image of the multi-device substrate corresponding to the image of the multi-device substrate, the annotated image comprising annotations corresponding to the identified defects.

14. The method of claim 13, wherein a size, a shape, or a type of annotation is based on a determined type of defect.

15. A non-transitory computer readable medium having one or more sequences of instructions stored thereon, which, when executed by a processor, causes a computing system to perform operations comprising:
receiving, by a computing system from an inspection device, an image of a multi-device substrate, the multi-device substrate comprising one or more regions, each region of the one or more regions having a plurality of devices formed thereon;
identifying, by the computing system, a golden die corresponding to the multi-device substrate, the golden die representing a canonical design of devices formed on the multi-device substrate;
analyzing, by the computing system, the image to identify defects in the image of the multi-device substrate by comparing the image of the multi-device substrate to the golden die;
mapping, by the computing system, locations of the identified defects to corresponding locations on the golden die;
based on the mapping, determining, by the computing system, one or more devices of the plurality of devices affected by the defects; and
generating, by the computing system, as output, an indication of the defects and the one or more devices affected by the defects.

16. The non-transitory computer readable medium of claim 15, further comprising:
identifying, by the computing system, a first region of the one or more regions of the multi-device substrate; and
determining, by the computing system, whether the first region fails inspection based on an amount and types of defects identified in the first region.

17. The non-transitory computer readable medium of claim 15, further comprising:
identifying, by the computing system, a first device of the plurality of devices formed on the multi-device substrate; and
determining, by the computing system, whether the first device fails inspection based on an amount and types of defects identified in a location corresponding to the first device.

18. The non-transitory computer readable medium of claim 15, wherein analyzing, by the computing system, the image to identify defects in the image of the multi-device substrate by comparing the image of the multi-device substrate to the golden die comprises:
applying a device mask to the image of the multi-device substrate, the device mask corresponding to the golden die.

19. The non-transitory computer readable medium of claim 15, wherein analyzing, by the computing system, the image to identify defects in the image of the multi-device substrate by comparing the image of the multi-device substrate to the golden die comprises:
iteratively applying one or more region masks to the one or more regions in the image of the multi-device substrate.

20. The non-transitory computer readable medium of claim 15, wherein generating, as output, the indication of the defects and the one or more devices affected by the defects comprises:
generating an annotated image of the multi-device substrate corresponding to the image of the multi-device substrate, the annotated image comprising annotations corresponding to the identified defects.
